(19) United States
(12) Patent Application Publication
(10) Pub. No.: US 2021/0016371 A1
(43) Pub. Date: Jan. 21, 2021

(54) TAPERED COUNTERSINK DRILL BIT

(71) Applicant: TENG-HUNG LIN, Kaohsiung City (TW)

(72) Inventor: TENG-HUNG LIN, Kaohsiung City (TW)

(21) Appl. No.: 16/512,343

(22) Filed: Jul. 15, 2019

(51) Int. Cl. B23B 51/10

(52) U.S. Cl. CPC B23B 51/108; B23B 2251/24; B23B 2251/202; B23B 2251/08

(57) ABSTRACT

A tapered countersink drill bit includes at least two screwing knifes and at least one two screwing trenches and a rod body; a length of an edge of the left lateral side of each screwing knife being shorten than that of an edge of the right lateral side thereof; each screwing knife including a front drilling head; a tapered portion formed at a backside of the front drilling head; a rear drilling head formed at a backside of the tapered portion; the screwing angle of each screwing knife being identical from the front drilling head to the rear drilling head; and a screwing angle of each screwing trench being identical from the front drilling head to the rear drilling head; a width between two adjacent knifes at a front end of the rear drilling head being longer than a width between two knifes at rear ends of two rear drilling head.

### FIELD OF THE INVENTION

The present invention is related to screws, and in particular to a tapered countersink drill bit.

### BACKGROUND OF THE INVENTION

In the prior art for forming a screw with screwing trenches, the drill with a smaller outer diameter is used to drill a through hole in a work piece. Then the drill is removed and a knife with large outer diameter is located on the through hole so as to form the screwing head of the screw. However, in this prior art, two steps are necessary for forming screw head. Furthermore this working method has two defects.

Two steps are needed and thus the quality for forming the screw is greatly affected by the worker. Furthermore two working processes are necessary and thus it is time inefficiency.

To improve the defect in the prior art, an improved method is to serially connect two drills of different outer diameters coaxially so as to form as a combined drill to simplify the process for forming the trenches in the screw head. In this combination, the drill of small size is assembled at a front end of the drill of larger size by a fixing stud. However, this structure has following defects. That is, the lifetime of the structure is shorter and the structure is weak due to usage of the fixing stud. The knifes and dreg removing trenches of the front and rear drills are not continuous and thus the dregs are not removed smoothly. The dregs generate a large resistance to affect the operation of drilling speed and production rate.

Therefore, there is an eager demand for a novel tapered countersink drill bit which can improve the defects in the prior art so as to prolong the lifetime of the screw and increasing the production rate.

### SUMMARY OF THE INVENTION

Accordingly, for improving above mentioned defects in the prior art, the object of the present invention is to provide a tapered countersink drill bit, wherein the front drill, the tapered portion, the rear drill and the rod body are formed as an integral structure. The screwing knifes and screwing trenches have identical screwing angle and specific design as above mentioned so as to remove dregs easily and quickly in drilling operation.

To achieve above object, the present invention provides a tapered countersink drill bit comprising: at least two screwing knifes (2) and at least one two screwing trenches (3) being formed between two adjacent screwing knifes (2); the screwing knifes (2) and the screwing trenches (3) being extended from a front end of a polygonal rod body (14); each screwing knife being formed by a left lateral side (121A) and a right lateral side (121B); a length of an edge of the left lateral side (121 A) being shorten than that of an edge of the right lateral side (121B); each screwing knife (2) comprising: a front drill (11); a tapered portion (12) formed at a backside of the front drill (11); an outer diameter of a front end of the tapered portion (12) being equal to that of a rear end of the front drill (11); a rear drill (13) formed at a backside of the tapered portion (12); an outer diameter of a rear end of the tapered portion (12) being equal to that of a front end of the rear drill (13); an outer diameter of the front drill (11) being smaller than that of the rear drill (13); the screwing angle of each screwing knife (2) being identical from the front drill (11) to the rear drill (13); and a screwing angle of each screwing trench (3) being identical from the front drill (11) to the rear drill (13); a width (3A) between two adjacent knifes (2) at a front end of the rear drill (13) being longer than a width (3B) between two knifes (2) at rear ends of two rear drill (13). An outer diameter of a front end of the tapered portion (12) is smaller than that of a rear end of the tapered portion (12).

### BRIEF DESCRIPTION OF THE DRAWINGS

FIG. 1 is a perspective view showing the first embodiment of the present invention, where three screwing knifes and three screwing trenches are shown.

FIG. 2 is a front view of FIG. 1.

FIG. 3 is a light side view of FIG. 2.

FIG. 4 is a perspective view showing the second embodiment of the present invention, where two screwing knifes and two screwing trenches are shown.

FIG. 5 is a right side view of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

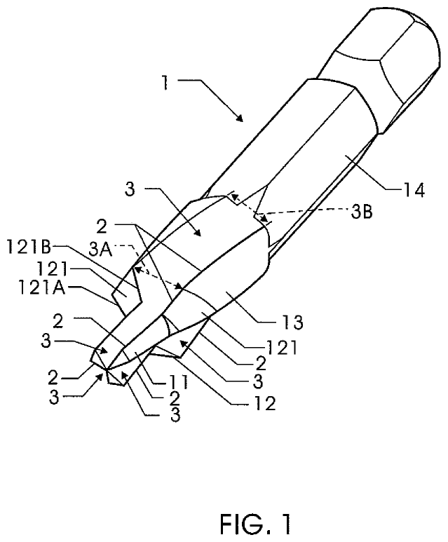

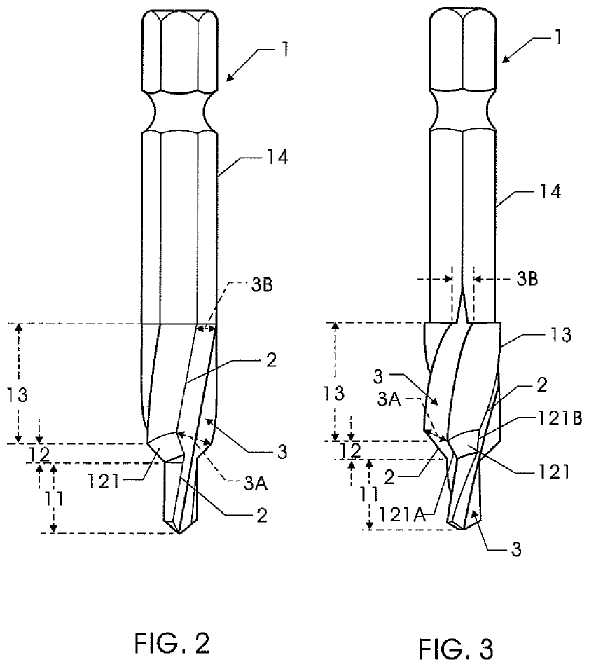

With reference to FIGS. 1 to 3, a preferred embodiment of the present invention is illustrated. The drilling head of the present invention (having three screwing knifes and three screwing dreg removing recesses) includes:

At least two screwing knifes 2 are included and at least one two screwing trenches 3 are formed between two adjacent screwing knifes 2. The screwing knifes 2 and the screwing trenches 3 are extended from a front end of a polygonal rod body 14.

Each screwing knife is formed by a left lateral side 121A and a right lateral side 121B. A length of an edge of the left lateral side 121 A is shorten than that of an edge of the right lateral side 121B.

Each screwing knife 2 includes the following portions:
A front drilling head 11 is included.
A tapered portion 12 is formed at a backside of the front drilling head 11. An outer diameter of a front end of the tapered portion 12 is equal to that of a rear end of the front drilling head 11. An outer diameter of a front end of the tapered portion 12 is smaller than that of a rear end of the tapered portion 12.
A rear drilling head 13 is formed at a backside of the tapered portion 12. An outer diameter of a rear end of the tapered portion 12 is equal to that of a front end of the rear drilling head 13. An outer diameter of the front drilling head 11 is smaller than that of the rear drilling head 13.

The screwing angle of each screwing knife 2 is identical from the front drilling head 11 to the rear drilling head 13; and the screwing angle of each screwing trench 3 is identical from the front drilling head 11 to the rear drilling head 13.

A width 3A between two adjacent knifes at a front end of the rear drilling head 13 is longer than a width 3B between two knifes at rear ends of two rear drilling head 13.

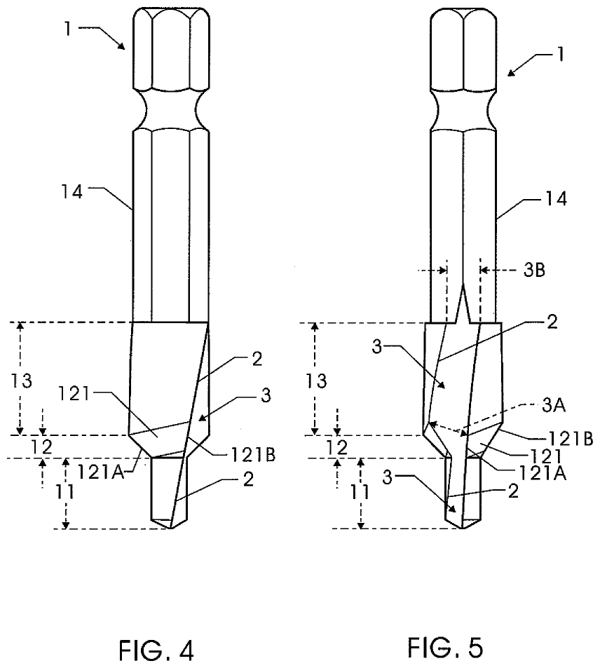

With reference to FIGS. 4 and 5, another embodiment of the present invention is illustrated. The drilling head of the present invention (having two screwing knifes and two screwing dreg removing recesses) includes:

Two screwing knifes 2 are included and two screwing trenches 3 are formed between two adjacent screwing knifes 2. The screwing knifes 2 and the screwing trenches 3 are extended from a front end of a polygonal rod body 14.

Each screwing knife 2 is formed by a left lateral side 121A and a right lateral side 121B. A length of an edge of the left lateral side 121 A is shorten than that of an edge of the right lateral side 121B.

Each screwing knife 2 includes the following portions:

A front drilling head 11 is included.

A tapered portion 12 is formed at a backside of the front drilling head 11. An outer diameter of a front end of the tapered portion 12 is equal to that of a rear end of the front drilling head 11. An outer diameter of a front end of the tapered portion 12 is smaller than that of a rear end of the tapered portion 12.

A rear drilling head 13 is formed at a backside of the tapered portion 12. An outer diameter of a rear end of the tapered portion 12 is equal to that of a front end of the rear drilling head 13. An outer diameter of the front drilling head 11 is smaller than that of the rear drilling head 13.

The screwing angle of each screwing knife 2 is identical from the front drilling head 11 to the rear drilling head 13; and the screwing angle of each screwing trench 3 is identical from the front drilling head 11 to the rear drilling head 13.

A width 3A between two adjacent knifes at a front end of the rear drilling head 13 is longer than a width 3B between two knifes at rear ends of two rear drilling head 13.

Therefore, the front drilling head, the tapered portion, the rear drilling head and the rod body are formed as an integral structure. The screwing knifes and screwing trenches have identical screwing angle and specific design as above mentioned so as to remove dregs easily and quickly in drilling operation.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A tapered countersink drill bit comprising:
at least two screwing knifes (2) and at least two screwing trenches (3) being formed between two adjacent screwing knifes (2) of the at least two screwing knifes (2); the screwing
knifes (2) and the screwing trenches (3) being extended from a front end of a polygonal rod body (14);
each screwing knife being formed by a left lateral side (121A) and a right lateral side (121B) and an upper side (121) between the left lateral side (121A) and the right lateral side (121B); a length of an edge of the left lateral side (121 A) being shorten than that of an edge of the right lateral side (121B);
each screwing knife (2) comprising:
a front drilling head (11);
a tapered portion (12) formed at a backside of the front drilling head (11); an outer diameter of a front end of the tapered portion (12) being equal to that of a rear end of the front drilling head (11);
a rear drilling head (13) formed at a backside of the tapered portion (12); an outer diameter of a rear end of the tapered portion (12) being equal to that of a front end of the rear drilling head (13); an outer diameter of the front drilling head (11) being smaller than that of the rear drilling head (13);
wherein the screwing angle of each screwing knife (2) is identical from the front drilling head (11) to the rear drilling head (13); and a screwing angle of each screwing trench (3) being identical from the front drilling head (11) to the rear drilling head (13);
a width (3A) between two adjacent knifes (2) at the front end of the rear drilling head (13) is longer than a width (3B) between two knifes (2) of the at least two screwing knifes (2) and at the rear ends of two rear drilling head (13).

2. (canceled)
